(19) United States
(12) Patent Application Publication
(10) Pub. No.: US 2002/0065899 A1
(43) Pub. Date: May 30, 2002

(54) System and method for delivering dynamic content

(76) Inventors: Erik Richard Smith, Arlington, VA (US); Paul Alan Conley, Centreville, VA (US); Vijayakumar Perincherry, Gaithersburg, MD (US); Michael Thomas Coram, Ashburn, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/997,237

(22) Filed: Nov. 30, 2001

Related U.S. Application Data
(60) Provisional application No. 60/253,939, filed on Nov. 30, 2000.

(51) Int. Cl. G06F 15/16; G06F 15/167

(52) U.S. Cl. 709/214; 709/203; 709/227

(57) ABSTRACT

The present invention provides for a system and method for delivering dynamic content to a client coupled to a network, wherein the client sends a request for the dynamic content to an origin site. The origin site is coupled to the network and also has access to a database. According to the present invention, a plurality of caches are coupled to the network, wherein each cache includes replicated data from the database and application logic to generate the dynamic content using the replicated data. A router redirects the client from the origin site to a cache selected from the plurality of caches, wherein the selected cache provides the dynamic content to the client.

### CROSS-REFERENCE TO RELATED APPLICATIONS

This application claims priority to co-pending U.S. Patent Application No. 60/253,939, entitled “System And Method For Delivering Dynamic Content Using Content Delivery Servers,” filed on Nov. 30, 2000, the entirety of which is incorporated herein by reference.

### BACKGROUND

1. Field of the Invention

The present invention relates generally to content delivery and more particularly to a system and method for delivering dynamic content over a content delivery network.

2. Discussion of the Related Art

The current content delivery network (CDN) model provides for the efficient delivery of static content. Static content can include, for example, web pages, digital images, or streaming audio/video. This content is made available on a distributed network of content delivery servers, referred to herein as edge caches. Upon receiving a request for content the CDN selects the edge cache that can provide the fastest delivery to the requesting client, rather than providing the content from a single server at a fixed point. Companies such as Akamai, Digital Island, and Speedera currently produce CDNs that utilize static caching.

Conventional CDNs for delivering static content include an origin site and one or more static edge caches. The CDN service provider leases space from Internet Service Providers (ISPs) for the placement of edge caches. A single CDN may consist of thousands of edge caches placed at ISPs around the country. Edge caches require less hardware than the server(s) located at a centralized site because each edge cache services a subset of the user base whereas the centralized site must have sufficiently powerful hardware to service all users. The modest hardware requirements of the edge cache allow for a smaller box (i.e., smaller form factor) which in turn reduces the ISP space leasing cost.

Clients access the CDN by sending requests to the origin site. For example, in the Internet environment, clients can issue HyperText Transfer Protocol (HTTP) requests to the origin site. The origin site composes an HTML response that includes image links corresponding to the CDN service provider. HTML with the inserted image links is then returned to the client. The client then requests an image from the CDN service provider using the image links.

Upon receiving the request, the CDN service provider selects an edge cache to provide the requested image content. Various metrics can be used to measure the “distance” between the client and a candidate edge cache. Examples include round robin, round trip time (RTT), and footrace metrics. A particular edge cache is then selected from amongst the candidates based on the aggregation of metric data and other various criteria that can vary from one implementation to the next. The selected edge cache is typically, but not necessarily, the one closest to the client in network terms. Other factors, such as network congestion along the path of delivery and server load, are taken into account in determining which edge cache is best suited to deliver the content.

The user request is then routed to the selected edge cache. Various approaches are known in the art for performing this routing. One common approach is based on a Domain Name System (DNS). The DNS routing mechanism utilizes the well known name-to-Internet Protocol (IP) address mechanism. An authoritative name server responds to a name request with an IP address that can vary depending on the location of the requesting client. The CDN service provider consults the name server and returns an IP address of the selected edge cache to the client. The client then sends the image request to the received IP address. The selected edge cache processes the received image request, and then sends the requested image content to the client. Other conventional routing algorithms can also be used to similar effect. Examples include an HTTP redirect algorithm, a Triangle algorithm, and a Proxy algorithm.

However, conventional CDNs are not particularly well suited to delivering dynamic content. Dynamic content generally refers to information on a web site or Web page that changes often, usually daily and/or each time a user reloads or returns to the page. Dynamic content is often generated at the moment it is needed rather than in advance, such as content that is structured based on user input. For example, when a user requests a keyword search on a search engine, the resulting page is a “dynamic” page, meaning the information was created based on the keywords provided by the user. Generally speaking, dynamic content will be generated in many different contexts where clients provide information and the web site generates a response based at least in part on the information.

Dynamic content may also be generated as a client navigates through a web site. Navigation involves selecting an option from a set of choices that determines which content will be returned in response. Sites that use navigation can be represented by a tree, with the “home page” as the root of the tree and the branches constructed from the set of paths from one page to the next. For small web sites, the pages are statically linked and there is no need for dynamic page generation. For web sites where the set of pages are large, such as a large product catalog organized by category, the set of pages becomes large and the ability to dynamically generate the pages upon request becomes desirable.

Web sites offering personalization also generate dynamic content. Personalization involves tailoring content to a specific user's preferences. An example would be a personalized home page (such as My Yahoo!™) where a user has preconfigured what content is shown on the user's home page. When the user requests their home page, the server looks up the user profile information in a database and then dynamically constructs the content based on the profile information. Personalization can be extended to cover a large portion of a user's interaction with a web site. Future wireless applications will add another dimension of personalization: the additional parameter of user location.

In a conventional CDN, the edge caches store content and deliver the content in response to those user requests that are redirected to the cache. However, conventional edge caches merely act as a repository of data and do not generate content locally. These edge caches can store dynamic content generated elsewhere, but are unable to generate dynamic content themselves. Upon receiving a request for dynamic content, the edge cache might check to see if the requested content had previously been generated and stored locally. If so, the edge cache might be able to satisfy the request by providing the previously generated content, though it's possible that this content has become stale since it was generated. Otherwise the dynamic content must be generated elsewhere and returned to the requesting user. Requiring the edge cache to look elsewhere for requested data undermines any performance improvements that would otherwise be gained by using the CDN.

For example, an origin site might perform a keyword search and generate a page describing the results of the search. This page might then be distributed to one or more edge caches, who would then be able to respond to a request for the identical search, albeit with possibly stale data (e.g., the database that was searched may have changed since the first search was performed, such that the search results would be different). The edge cache would be unable to respond to a request for a different search.

What is therefore needed is an improved content delivery network capable of efficiently delivering dynamic content.

### SUMMARY OF THE INVENTION

The present invention provides for a system and method for delivering dynamic content to a client coupled to a network, wherein the client sends a request for the dynamic content to an origin site. The origin site is coupled to the network and also has access to a database. According to the present invention, a plurality of caches are coupled to the network, wherein each cache includes replicated data from the database and application logic to generate the dynamic content using the replicated data. A router redirects the client from the origin site to a cache selected from the plurality of caches, wherein the selected cache provides the dynamic content to the client.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts a digital network environment wherein a CDN is used to deliver dynamic content to clients according to various example embodiments of the present invention.

FIGS. 2A through 2D depict the initial population and updating of data within a CDN, where

FIG. 2A depicts an initial state prior to any data having been loaded in the edge caches,

FIG. 2B depicts an initial data population process,

FIG. 2C depicts a data update process, and

FIG. 2D depicts a state wherein the initial data population has been completed but the update stream continues.

FIG. 3 is a flowchart that describes the operation of a CDN according to an example embodiment of the present invention.

FIG. 4 depicts an example implementation of a CDN in greater detail according to an example embodiment of the present invention.

FIG. 5 is a flowchart that describes an example execution operation in a first example execution environment.

FIG. 6 is a flowchart that describes an example execution operation in a second example execution environment.

### DETAILED DESCRIPTION

Techniques according to the present invention are described herein for delivering dynamic content over a CDN. Efficient delivery of dynamic content is achieved by generating the content at the edge caches rather than at the origin site. This is accomplished by replicating at the edge caches the application logic responsible for generating the dynamic content and the data accessed by the application logic. Edge caches within this improved content delivery network are therefore able to respond to client requests for dynamic content by generating the content locally and responding to the request.

The present invention includes one or more computer programs which embody the functions described herein and illustrated in the appended flowcharts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flowcharts and associated written description included herein. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

### Overview

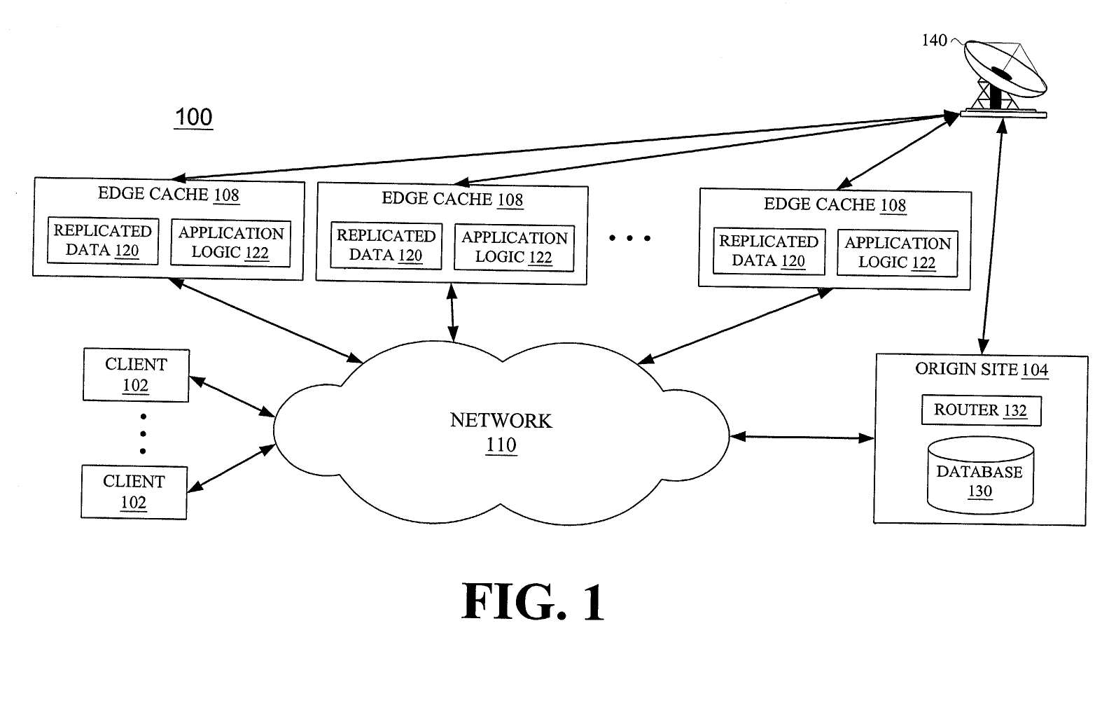

FIG. 1 depicts a digital network environment 100 wherein a CDN is used to deliver dynamic content to clients 102 according to various example embodiments of the present invention. Digital network environment 100 includes an origin site 104 and two or more edge caches 108 distributed across a network 110. Edge caches 108 include replicated data 120 and application logic 122. Origin site 104 includes a database 130 and a router 132. According to the present invention, the capability of generating dynamic content is moved to the edges of the CDN by distributing application logic 122 and replicated data 120 to edge caches 108. Application logic 122 describes how to generate the dynamic content, and replicated data 120 represents the data necessary to generate the content. CDNs according to the present invention are therefore better able to distribute dynamic content because this content can be generated at the edges and efficiently provided to nearby clients 102.

Communications between the various entities within digital network environment 100 can occur via network 110, such as the Internet, a local area network, a wide area network, a wireless network, or any combination of the above. The various components of environment 100 can also communicate via a satellite communications network 140. For example, large quantities of information can be efficiently transported from origin site 104 to edge caches 108 using satellite communications network 140, rather than (or in conjunction with) network 110.

Client 102 represents a consumer of data provided by the CDN, such as an end-user using a web browser (such as Netscape Navigator™ or Internet Explorer™). Client 102 can also represent an automated computer program rather than an individual, where the delivered content might, for example, be Extensible Markup Language (XML) instead of Hypertext Markup Language (HTML). The CDN can therefore provide dynamic content in a number of contexts, such as business to business (B2B) applications, wireless applications, and Intelligent Agent Systems.

Origin site 104 represents the computer equipment and software necessary to operate a web site of interest to clients 102. For example, central database 130 represents a database system that can include hardware to physically store data, and a database management system (DBMS) to provide access to information in the database. The DBMS is a collection of programs that enables the entry, organization, and selection of data in a database. With respect to the hardware, database machines are often specially designed computers that store the actual databases and run the DBMS and related software.

Router 132 routes client requests directed to origin site 104 to a selected edge cache 108 for handling. For example, router 132 can be implemented as a Global Server Load Balancing (GSLB) router. GSLB routers, for example, seek to match clients 102 with an edge cache 108 that can efficiently handle (relative to the other edge caches in the CDN) the HTTP session for the client.

Edge cache 108 can represent a server, preferably a dedicated machine, configured to process client requests. Edge caches 108 can be placed throughout network 110 to provide coverage for a large number of clients 102. For example, in the Internet context, edge caches 108 can be placed in ISPs around the country and throughout the world, in all geographic areas where high-speed access to data stored in database 130 is sought to be provided. As will be apparent, the distribution and concentration of edge caches 108 within network 110 can be tailored to provide desired levels of access to clients 102 in different geographic locales.

Replicated data 120 represents an image of at least a portion of the data stored in database 130. As described below, an update process is employed to intermittently refresh replicated data 120 with a more timely snapshot of the data in database 130. Replicated data 120 can be stored within, or be accessible to, edge cache 108. For example, a main memory database (MMDB) architecture (also referred to as an In-Memory Database (IMDB)) can be used within edge cache 108 to store replicated data 120. An MMDB stores data in high-speed random access memory (RAM), providing the ability to process database requests orders of magnitude faster than traditional disk based systems. The faster response time of edge cache 108 and the proximity of the edge cache to client 102 provides an increase in performance for those database requests that can be handled by the cache. As will be apparent, other cache architectures may be used to store replicated data 120. Further, a secondary disk based cache can also be used to handle larger or less frequently used data objects.

According to a first example embodiment of the present invention, replicated data 120 represents whole database tables. According to other example embodiments, replicated data 120 can represent partial tables. For example, partial table caching techniques can be used when a table is marked for Point Queries (PQ). The allowed set of queries against a PQ table is more restrictive than the general case. PQ tables retrieve single records based only on the primary table key. The advantage of PQ tables is that they can be partially cached. This means that the most recently used (MRU) records are kept resident in the cache and the least recently used (LRU) are flushed out of the cache. The typical PQ table application is for user profile data, which involves only PQ requests. For example, a user profile table may contain data for 10 million users, but edge cache 108 need only contain the information pertaining to the users who access that cache with some frequency.

Application logic 122 represents the computer software resident at edge cache 108 for processing client requests, including generating dynamic content based on the particular request. Application logic 122 issues database requests as required during the processing of a client request, where the database request can be satisfied by replicated data 120 and/or database 130. For example, the processing of an HTTP client request might require the issuing one or more database requests for desired information. Database requests can be either informational or transactional in nature. Read-only requests for database information are referred to herein as informational database requests, whereas requests to modify database information are referred to herein as transactional database requests.

Application logic 122 can represent multiple software programs where different programs are used to process different client requests. For example, a first software program might be invoked to process requests to search for a specified keyword, whereas a second software program might be invoked to support dynamic page generation as the client navigates through the pages of a web site. In the Java execution environment, application logic 122 can represent multiple servlets. Edge cache 108 can determine which portion of application logic 122 to execute by, for example, examining the Universal Resource Locator (URL) that was provided by the client and determine the servlet that will generate a response for the client request.

Edge cache 108 can provide different interfaces depending upon the type of application logic 122. For example, edge caches 108 can be configured to support multiple execution environments that present different interfaces for application logic 122, such as Java Server Pages (JSP)/Servelets, Active Server Pages (ASP), Perl, and PHP Hypertext Processor (PHP). For Java based application logic, a Java Database Connectivity (JDBC) environment is provided. For Active Server Page (ASP) logic, an Open Database Connectivity (ODBC) environment is provided. The interface for each execution environment has a local data fetch mode and a facilitator mode. The local data fetch mode is used when the requested data is included within replicated data 120. Otherwise the facilitator mode is used and the edge cache facilitates communication with central database 130.

According to an example embodiment of the present invention, central database 130 and edge caches 108 store database information as relational data, based on the well known principles of Relational Database Theory wherein data is stored in the form of related tables. Many database products in use today work with relational data, such as products from INGRES, Oracle, Sybase, and Microsoft. Structured Query Language (SQL) is a language that is commonly used to interrogate and process data in a relational database. Example embodiments of the present invention may be described herein in the context of using SQL commands to access a relational database. However, other alternative embodiments of the present invention might employ different data models, such as object or object relational data models.

Different parties can provide the various components of the CDN. For example, an operator of origin site 104 may wish to provide faster delivery of dynamic content to their clients 102. The site operator might obtain the back-end infrastructure such as central database 130 from a first vendor that specializes in providing this type of equipment (e.g., Oracle). A second vendor offering CDN components might then supply edge caches 108, as well as whatever supporting hardware or software might be required at origin site 104 to manage edge caches 108. The CDN provider might therefore extend the services already provided by the operator of origin site 104, rather than providing an end-to-end solution which would require having to build an encompassing solution. In this context, the back-end infrastructure providers have an increased incentive to participate in the CDN as compared to a conventional static CDN, because these providers play a more significant role in the dynamic CDN as compared to the static CDN.

The following sections describe the operation of a CDN according to various example embodiments of the present invention. Network initialization is described in the following section. This is followed by sections describing the operation of an improved CDN for the delivery of dynamic as well as static content according to various example embodiments of the present invention. Specific example implementations of the various CDN components are also described in detail.

### Edge Cache Initialization

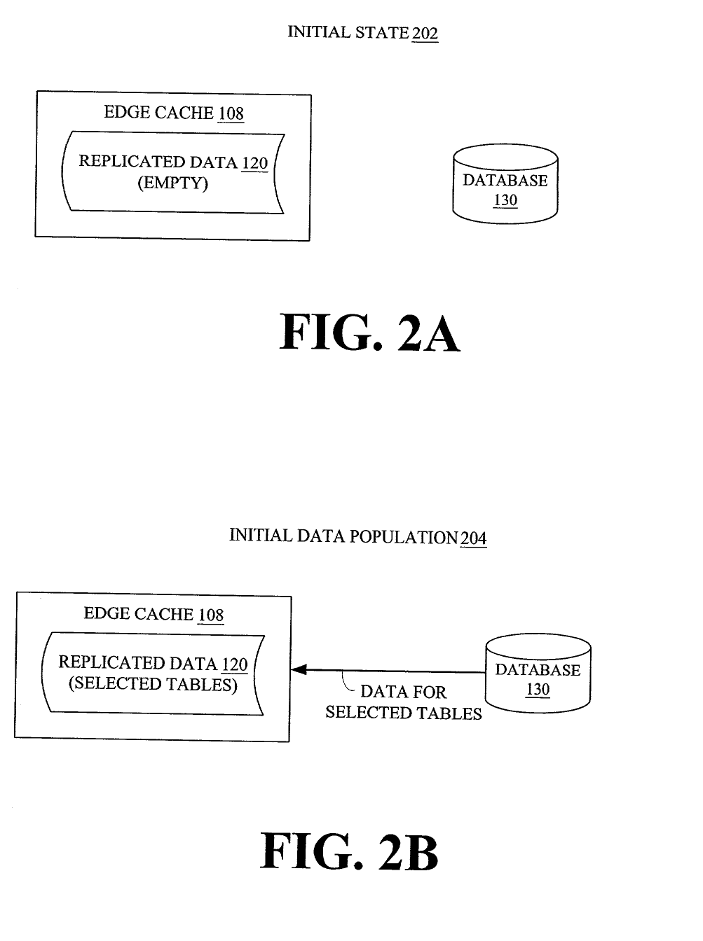

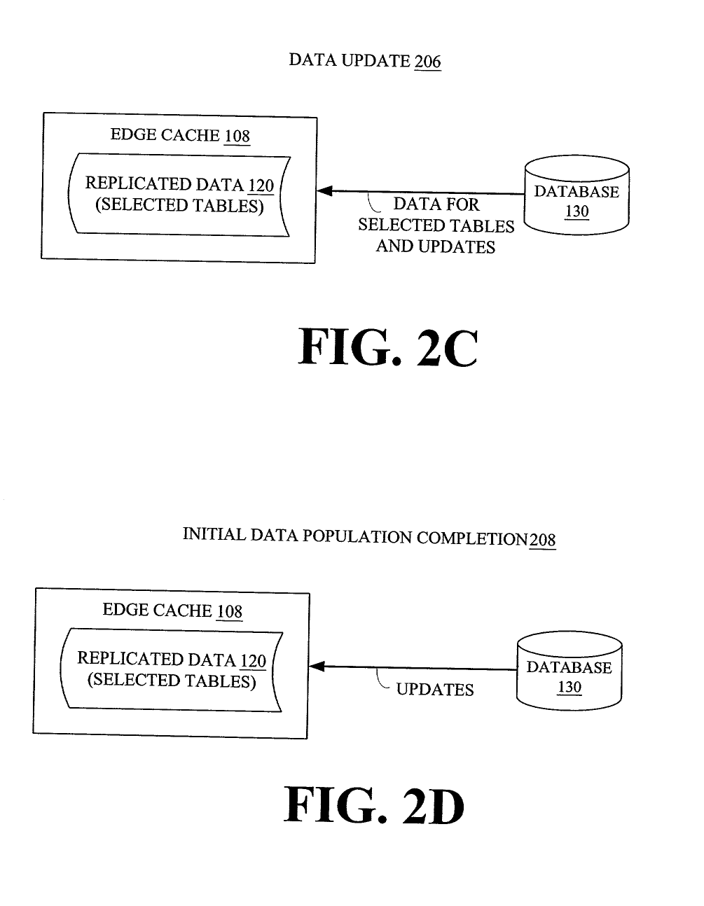

According to the present invention, the CDN employs several initial and continuing processes having to do with configuration of the network, including initial data population, data update propagation, and transactional communication. FIGS. 2A through 2D depicts a representative edge cache 108 and database 130 in various states according to these processes.

FIG. 2A depicts an initial state 202 prior to any data having been loaded in edge cache 108. Initial state 202 might occur, for example, upon installation of a new edge cache 108 within the CDN. FIG. 2B depicts an initial data population process 204, wherein the edge caches 108 are initially populated with data replicated from database 130. Whole data sets (e.g., tables) are sent from database 130 to the edge caches 108 where the data can be stored, for example, in an MMDB. This initial data population process might be used when a CDN is first installed to provide data to a large number of edge caches 108. Alternatively, the initial data population process might be used to provide data to a relative small number of new edge caches 108 that are added to an existing CDN. As mentioned above, satellite communications network 140 can be used to transport these relatively large sets of data in an efficient manner, either in lieu of or in conjunction with network 110.

FIG. 2C depicts a data update process 206, wherein updates that occur to the data stored in database 130 are propagated to edge cache 108. Consistency is thereby maintained between database 130 and replicated data 120. Depending upon the implementation, the data can be updated at different levels of granularity. According to an example embodiment of the present invention, changes to database 130 are tracked at the level of rows within a table. As changes are made to database 130, the updated rows are propagated out to edge caches 108 to replace the now stale replicated data. As indicated in FIG. 2C, data updates can be sent independently of and concurrently with the initial data population process 204.

FIG. 2D depicts a state 208 wherein the initial data population has been completed but the update stream continues. State 208 can represent, for example, the normal operating condition for an installed CDN. As will be apparent, the operation of a CDN can transition from state 208 to one of the other states or processes described above upon the occurrence of certain events. For example, a CDN might execute processes 204 or 206 upon the addition of a new edge cache 108.

Similar processes can be employed to propagate application logic from origin site 104 to edge caches 108. As with data communication, this can include both initial population and update processes. Initial population of application logic 108 from origin server 104 might be necessary if edge cache 108 is not pre-loaded with the necessary software for generating the dynamic content of interest to the CDN. Further, the update process can be valuable to disseminate newer versions of application logic 108, such as updating old functionality, adding new functionality, or adding support for different execution environments. As described in greater detail below, origin site 104 can include an application server to handle, amongst other things, the propagation of application logic 122 to edge caches 108.

### Operation of Content Delivery Network

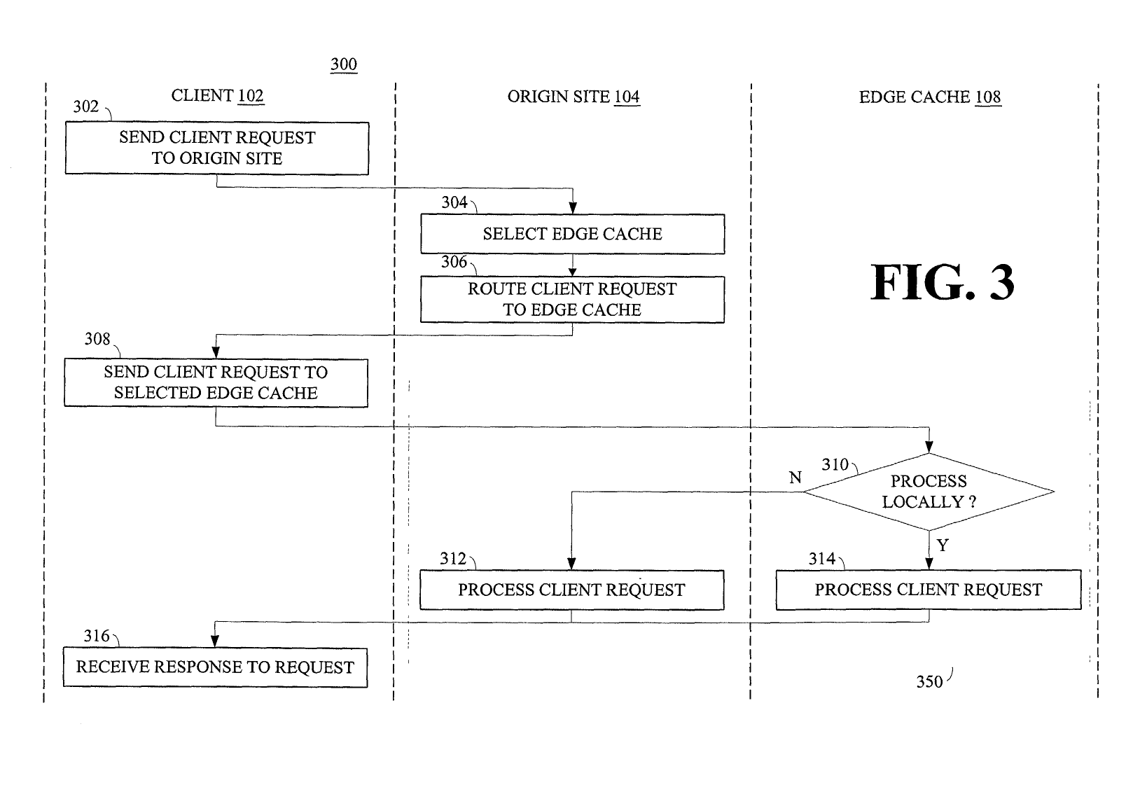

FIG. 3 is a flowchart 300 that describes the operation of a CDN according to an example embodiment of the present invention. FIG. 3 depicts operations performed by client 102, origin site 104, and edge cache 108. Further, these operations are described in the context of a HTTP environment, such as the Internet. As will be apparent, the general concepts described herein are applicable to other environments as well.

In operation 302, client 102 generates an HTTP client request directed to origin site 104. As described above, the HTTP request may be from an Internet Web browser or from an automated process. For example, the request might be a keyword search initiated by client 102.

Origin site 104 receives the request, and, in operation 304, selects an edge cache 108 from the CDN to handle processing of requests from client 102. Any conventional technique for selecting a cache to service the requesting client 102 may be used, such as the distance metrics described above. In operations 306 and 308, origin site 104 routes the client request to the selected edge cache 108 including a round trip to client 102. Conventional routing techniques may be used to route client requests, such as DNS techniques, an HTTP redirect algorithm, a Triangle algorithm, or a Proxy algorithm. According to an example embodiment of the present invention, operations 304 and 306 are performed by a GSLB router 132.

In operation 310, the selected edge cache 108 determines whether the client request should be processed locally (i.e., by edge cache 108) in operation 314 or whether the request should be processed at origin site 104 in operation 312. These three operations are also collectively depicted in FIG. 3 as the execution operations 350. Later sections describe the execution operations 350 in greater detail for various example execution environments.

Those client requests that are informational in nature are processed at edge cache 108 in operation 314. Application logic 122 might issue one or more informational database requests as these client requests are processed. If replicated data 120 includes the data that is the target of the database requests, then the database request can be satisfied locally. However, if the target data is not replicated locally, then edge cache 108 forwards the informational database request on to database 130 to retrieve the target data.

Client requests that are transactional in nature are processed, at least in part, at origin site 104 in operation 312. The processing of these transactional client request might require the issuance of one or more transactional database requests as well as informational database requests. Transactional database requests are processed at origin site 104 on the data stored in database 130, whereas the informational database requests may be processed at either origin site 104 or edge cache 108. Various example embodiments are contemplated within the scope of the present invention for processing these transactional and informational database requests.

According to a first example embodiment of the present invention, transactional client requests are deflected to origin site 104 for processing. Edge cache 108 sends a redirect request to client 108 which causes client 108 to re-send the client request to origin site 104. Origin site 104 processes the deflected client request, issuing both transactional database requests and informational database requests as required by the request. Origin site 104 sends a response to the client request which is received by client 102 in operation 316.

According to a second example embodiment of the present invention, a high-level proxy technique is employed wherein edge cache 108 proxies (or forwards) the client request to origin site 104. Origin site 104 processes the client request, including the transactional and informational database requests, and returns a response to edge cache 108. Edge cache 108 then sends a response to client 102.

According to a third example embodiment of the present invention, a low-level proxy technique is employed wherein edge cache 108 processes the client request, and handles the database requests according to their type. Transactional database requests are forwarded to origin site 104 for processing on database 130. Informational database requests are satisfied locally from replicated data 120, assuming that replicated data 120 includes the target data. Otherwise, the informational database request is also forwarded to database 130 to retrieve the target data, which is then returned to edge cache 108.

With respect to the latter two example embodiments (i.e., the high- and low-level proxy techniques), consistency between client requests might not be maintained. For example, this can occur in the following circumstance. A first transactional client request results in data being updated in database 130. A second informational client request accesses the data that has just been updated within replicated data 120, but before the updates have been propagated from database 130 to replicated data 120. The second informational client request will therefore retrieve data inconsistent with the first transactional request.

Consistency between client transactions can be improved if additional procedures are followed. In a first example embodiment for maintaining client consistency according to the present invention, edge cache 108 suspends the processing of client requests once a transactional request is forwarded to origin site 104, and until replicated data 120 has been updated to reflect the results of the transaction. Origin site 104 can monitor the receipt of transactional client requests and/or database request and use the receipt of such to trigger a data update process 206 once the transaction is complete. As applied to the high-level proxy technique, after forwarding a transactional client request to origin site 104 edge cache 108 suspends the processing of subsequent client requests received from the same client until replicated data 120 has been updated. As applied to the low-level proxy technique, after forwarding a transactional database request to origin site 104 edge cache 108 suspends the processing of the current client request until replicated data 120 has been updated.

In a second example embodiment for maintaining client consistency according to the present invention, edge cache 108 forwards all requests subsequent to a transactional request from the same client to origin site 104 until replicated data 120 has been updated to reflect the transactional request. As with the previous example embodiment, this technique can be applied to both high- and low-level proxy. With high-level proxy, after forwarding a transactional client request to origin site 104 edge cache 108 forwards subsequent client requests (both informational and transactional) to origin site 104 until replicated data 120 has been updated. Similarly for low-level proxy, after forwarding a transactional database request to origin site 104 edge cache 108 forwards subsequent database request (both informational and transactional) for the current client request to origin site 104 until replicated data 120 has been updated. In each of these implementations, edge cache 108 stores information indicating whether requests from a particular client are being handled normally, or are being forwarded to origin site 104 pending receipt of updated replicated data 120. This information can, for example, be maintained in a table that includes entries for all clients 108 currently communicating with edge cache 108.

In operation 316, a response to the request is received by client 102, whether from edge cache 108 or origin site 104. As will be apparent, a typical interaction between client 102 and origin site 104 can include several client requests followed by responses. On subsequent iterations of operations 302 to 316, client 102 continues to interact with the selected edge cache 108.

### Example Edge Cache and Origin Site Implementation

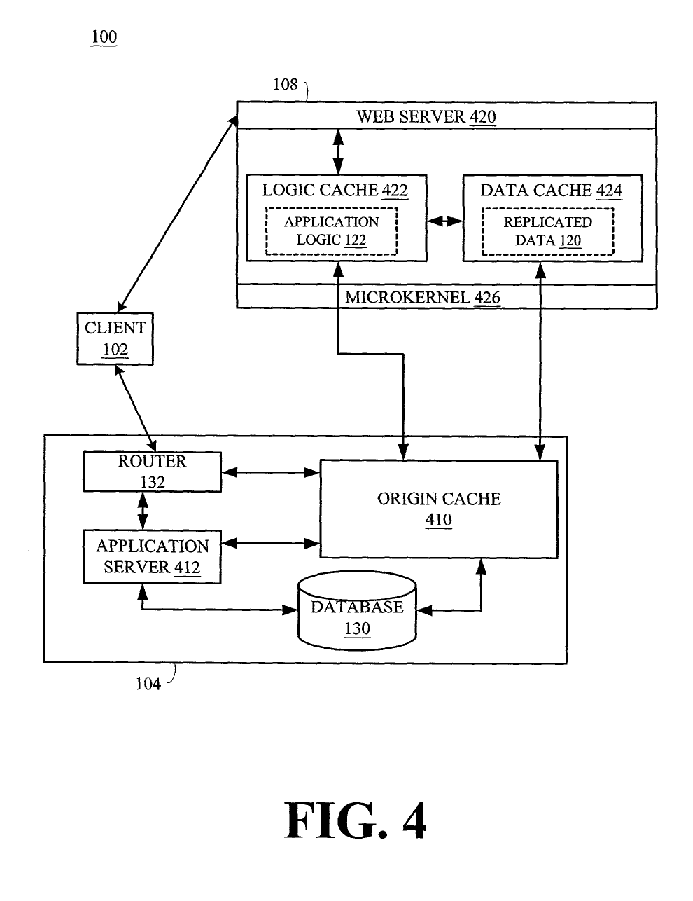

FIG. 4 depicts an example implementation of a CDN in greater detail according to the present invention. Origin site 104 includes an application server 412 and an origin cache 410 in addition to router 132 and database 130. Edge cache 108 includes a web server 420, a logic cache 422, a data cache 424, and a microkernel 426. As will be apparent, this is but one of many possible implementations contemplated to be within the scope of the present invention capable of performing the operations described herein.

Web server 420 forms the interface with client 102 by receiving requests from client 102 and returning the responses generated by application logic 122 to client 102 according to the specific network protocol. Logic cache 422 stores application logic 122 for execution at edge cache 108. Logic cache 422 communicates with origin cache 410 to access data from database 130 and application logic from application server 412. Data cache 424 stores replicated data 120, and can be accessed by application logic 122. Data cache 424 can represent, for example, an MMDB. Microkernel 426 represents a simple operating system for edge cache 108, and can alternatively be replaced by a general purpose operating system such as Linux or Windows.

Application server 412 can be used with the JSP/Servlet execution environment. A JSP or Servlet program running on edge cache 108 can interact with application logic that resides on a Java application server, such as Enterprise JavaBean (EJB) or Java 2 Platform, Enterprise Edition (J2EE) servers. The J2EE application server supports a remote method invocation (RMI) protocol that provides this capability. ASP scripts use a COM+ communication protocol.

Edge cache 108 does not necessarily communicate directly with either database 130 or application server 412, but instead uses router 132 as an intermediary. In this capacity, router 132 handles the translation between the edge cache protocol and the back-end components. Router 132 is therefore able to provide robust communication security between edge cache 108 and the back-end components. Router 132 is also able to provide efficient communication mechanisms. For example, router 132 can employ compression techniques for the transmission of both data and logic. Router 132 can also use delta encoding for application logic updates, whereby only the part of the application logic that has changed is sent rather than the entire application logic package.

The portion of application logic 122 that deals with content execution is separated from the portion that is transaction oriented. For example, the J2EE platform has two areas where application logic resides: JSP/Servlets, and EJBs. For JSP/Servlets, all of the available application logic can be accessed and distributed. For EJB application logic (referred to herein as beans), only non-transactional application logic can be distributed. Each bean has a property that indicates whether it is transactional or not.

A JSP/Servlet program running on edge cache 108 can invoke a bean via an RMI interface. If the bean is resident in edge cache 108, it can be executed at the edge. If it is not resident, then RMI is used to facilitate communication between the application logic on edge cache 108 and the executing bean on the back-end application server 412. In this case, the JSP/Servlet program will try to “invoke” a bean and will either execute the invocation locally or will use RMI to proxy the invocation to the origin.

The following two sections describe the operation of edge cache 108 when processing requests having JDBC requests or EJB invocations. As will be apparent, the edge caches 108 can be configured to handle other execution environments in addition to or in place of these environments, such as Active Server Pages (ASP) and Microsoft Transaction Services (MTS).

### Processing JDBC Requests

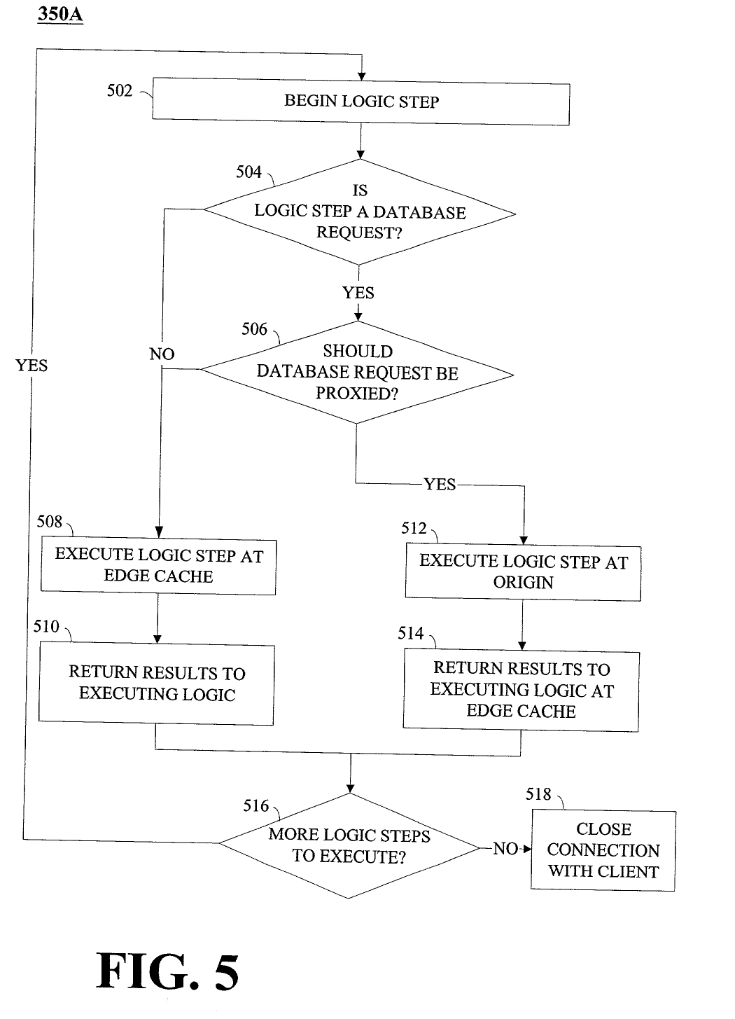

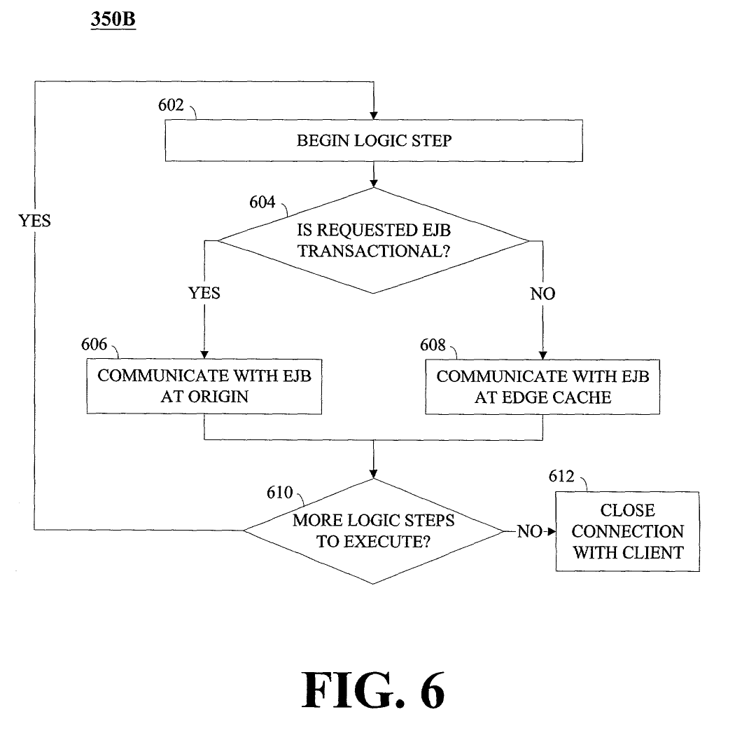

FIG. 5 is a flowchart that describes execution operations 350 in greater detail when processing JDBC requests. In operation 502, edge cache 108 begins executing a logic “step”. As used herein, steps refer to blocks of execution separated by events of interest, such as a JDBC request or an EJB invocation (described below in conjunction with FIG. 6). Application logic 122 can include one or more logic steps. A single request can include both JDBC request steps and EJB invocation steps. In these cases, edge cache 108 may alternate between the operations depicted in FIGS. 5 and 6, depending upon which step of application logic 122 is currently being processed. Further, each logic step may or may not include a database request, whether transactional or informational.

In operation 504, edge cache 108 determines whether the current logic step includes a database request. If not, the current logic step is executed in operation 508, with the results returned to the executing logic in operation 510. If so, a determination is made in operation 506 as to whether the database request should be forwarded to origin site 104 for processing.

Many different criteria, or combinations of criteria, can be applied to determine whether the database request should be proxied. As described above, transactional database request should be proxied. An isolation level and/or a concurrency setting associated with the current logic step can also be analyzed to determine whether the request is appropriate for cache processing. Certain driver environments allow a transaction isolation level to be associated with the request. According to an example embodiment of the present invention, the isolation level is compared to a first threshold. Only those requests having an isolation level less than or equal to the first threshold are determined to be appropriate for processing by edge cache 108. Those requests having an isolation level greater than the first threshold are determined to be inappropriate for cache processing and are executed at database 130.

Other driver environments may allow a related setting called the concurrency setting. This setting is roughly the inverse of the transaction isolation level. The concurrency setting is compared to a second threshold. Those requests that meet or exceed the second threshold are considered appropriate for processing by edge cache 108. Still other driver embodiments, such as the ODBC standard, provide for both an isolation level and a concurrency setting. Alternative embodiments of the present invention are contemplated wherein neither of these measures is considered, either one is considered, or both are considered when determining the appropriateness of cache processing.

Another criteria which can be considered when determining whether a database request should be proxied is whether the tables requested by the database request (i.e., the target of the database request) are contained in data cache 424. The request is considered appropriate for cache processing if the data accessed by the request is stored locally in data cache 424. Otherwise, the request is sent to database 130 for processing. Application logic 122 makes this determination by directly querying data cache 424 for its contents.

As will be apparent, additional criteria or combinations of criteria can be applied to determine whether the request is otherwise suitable for processing by edge cache 108. The criteria analyzed in this operation may vary according to the database language used. In the example SQL embodiment, the request is checked to see if all SQL features are supported by edge cache 108. The general complexity of the request may also be checked for cache support. Edge cache 108 may also decline the request if it is determined that edge cache 108 cannot handle the request efficiently.

If it is determined that the database request should not be proxied, then the database request is executed at edge cache 108 in operation 508, with the results returned to the executing logic in operation 510. If it is determined that the database request should be proxied, then the database request is forwarded on to origin site 104 for processing. Origin site 104 processes the database request, and returns the results (if any) to the executing logic (at edge cache 108) in operation 514. In operation 516, it is determined whether more logic steps are to be to executed. If so, the next logic step begins executing in operation 502. Otherwise, in operation 518 the connection with client 102 is closed.

### Processing EJB Invocations

FIG. 6 is a flowchart that describes the execution operations 350 in greater detail when processing EJB invocations. In operation 602, edge cache 108 begins executing the current logic step. A servlet can initiate communication with a Java Bean and cause it to execute logic. In operation 604, it is determined whether the requested EJB is transactional. If the requested EJB is not transactional, then in operation 608 communication is established with the bean directly at edge cache 108.

If the requested EJB is transactional, then in operation 606 communication is established with the bean at origin site 104 through origin cache 410. Edge cache 108 initiates a Java Remote Method Invocation (RMI) session with origin cache 410, which in-turn communicates with application server 412 where the Java Bean will execute on behalf of the executing logic at the edges.

In operation 610, it is determined whether more logic steps are to be to executed. If so, the next logic step begins executing in operation 602. Otherwise, in operation 612 the connection with client 102 is closed. However, in some circumstances it may be desirable to keep the connection with client 102 rather than closing the connection in either operation 522 or 612. The connection can be kept open for some period of time in anticipation of more requests by the client. This is referred to in the relevant art as a persistent connection.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

The previous description of exemplary embodiments is provided to enable any person skilled in the art to make or use the present invention. While the invention has been particularly shown and described with reference to exemplary embodiments thereof, it will be understood by those skilled in the art that various changes in form and details may be made therein without departing from the spirit and scope of the invention.

What is claimed is:

1. A system for delivering dynamic content to a client coupled to a network, wherein the client sends a request for the dynamic content to an origin site coupled to the network, and wherein the origin site accesses a database, the system comprising:
a plurality of caches coupled to the network, each including:
data replicated from the database, and
application logic to generate the dynamic content using said data; and
a router to route the request from the origin site to a cache selected from said plurality of caches.

2. The system of claim 1, wherein the origin site includes an application server to deliver said application logic to said plurality of caches via the network.

3. The system of claim 2, wherein said application logic comprises a servlet program and the application server interacts with said servlet program according to a Remote Method Invocation (RMI) protocol.

4. The system of claim 2, wherein communications between said plurality of caches, the database, and the application server are directed through said router, and said router is configured to perform protocol translations.

5. The system of claim 4, wherein said router is further configured to provide security for said communications.

6. The system of claim 4, wherein said router is further configured to provide compression for said communications.

7. The system of claim 4, wherein said router is further configured to provide delta encoding for updating said application logic.

8. The system of claim 1, wherein said application logic generates the dynamic content based at least in part on information provided by the client.

9. The system of claim 1, wherein the client comprises an individual end user.

10. The system of claim 1, wherein the client comprises an automated computer program.

11. The system of claim 1, wherein said plurality of caches are each configured to operate in a plurality of execution environments.

12. The system of claim 1, wherein said plurality of caches each include a main memory database (MMDB) to store said data.

13. The system of claim 12, wherein said plurality of caches each further includes a secondary cache.

14. The system of claim 1, wherein said data is transferred from the database to said plurality of caches via a satellite communications network.

15. The system of claim 1, wherein the database comprises a database management system (DBMS) and one or more database servers.

16. The system of claim 1, wherein said router comprises a Global Server Load Balancing (GSLB) router.

17. The system of claim 1, wherein said application logic of said selected cache generates the dynamic content in response to the request.

18. The system of claim 1, wherein said selected cache is configured to determine whether the request is transactional or informational, and if transactional, to proxy the request to the origin site, and if informational, to process the request using said application logic.

19. The system of claim 1, wherein said application logic issues a database request when processing the request, and wherein said selected edge cache is configured to determine whether said database request is transactional or informational, and if transactional, to proxy said database request to the origin site, and if informational, to process said database request using said application logic.

20. An edge cache for delivering dynamic content to a client coupled to a network, wherein the client sends a request for the dynamic content to an origin site coupled to the network, and wherein the origin site includes a database and an application server, said edge cache comprising:
a data cache to store data, wherein said data is replicated from the database; and
a logic cache to store application logic received from the application server, wherein said application logic generates the dynamic content in response to receiving the request.

21. A method for delivering dynamic content to a client coupled to a network, wherein the client sends a request for the dynamic content to an origin site coupled to the network, and wherein the origin site accesses a database, said method comprising:
selecting a cache from a plurality of caches coupled to the network;
routing the request to said cache;
executing application logic at said cache to generate the dynamic content, wherein said application logic accesses data stored in said cache, and wherein said data is replicated from the database; and
sending the dynamic content to the client in response to the request.

22. The method of claim 21, wherein the origin site includes an application server, and wherein said method further comprises distributing said application logic from the application server to said cache.

23. The method of claim 21, wherein said executing comprises determining whether the request is transactional or informational, and if transactional, forwarding the request to the origin site, and if informational, processing the request at said cache.

24. The method of claim 21, wherein said executing comprises:
issuing a database request; and
determining whether said database request is transactional or informational, and if transactional, forwarding said database request to the origin site, and if informational, processing said database request at said cache.

25. The method of claim 21, wherein said executing comprises:
issuing a database request; and
determining whether said database request is transactional or informational, and if informational, processing said database request at said cache, and if transactional:
forwarding said database request to the origin site, and
suspending operation until said data has been updated to reflect said database request.

26. The method of claim 21, wherein said executing comprises:
issuing a database request; and
determining whether said database request is transactional or informational, and if informational, processing said database request at said cache, and if transactional:
forwarding said database request to the origin site, and
forwarding subsequent database requests to the origin site until said data has been updated to reflect said database request.
